(19) United States
(12) Patent Application Publication
(10) Pub. No.: US 2008/0172709 A1
(43) Pub. Date: Jul. 17, 2008

(54) SERVER AND METHOD FOR PROVIDING PERSONAL BROADCAST CONTENT SERVICE AND USER TERMINAL APPARATUS AND METHOD FOR GENERATING PERSONAL BROADCAST CONTENT

(75) Inventors: Ga-hyun RYU, Suwon-si (KR); Kyung-sun CHO, Seoul (KR); Sun-hee YOUM, Seoul (KR); Sung-il PARK, Suwon-si (KR); Jong-hwa KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/014,953

(22) Filed: Jan. 16, 2008

(30) Foreign Application Priority Data
Jan. 16, 2007 (KR) 10-2007-0004968

(51) Int. Cl. H04N 7/173

(52) U.S. Cl. 725/114

(57) ABSTRACT

Provided are an apparatus and method for generating personal broadcast content. A user terminal apparatus includes a broadcast reception unit receiving broadcast content through a broadcast network; a communication unit controlling connection with a server which provides an authoring tool for generating personal broadcast content and metadata required to obtain one or more pieces of content through the broadcast network and a bi-directional communication network; a user input unit receiving a user input signal; and a control unit configuring a personal broadcast screen, which contains the content, using the authoring tool and the metadata and generating personal broadcast content in response to the user input signal. When the apparatus and method are used, a user can generate personal broadcast content using content which can be obtained through a bi-directional communication channel and a broadcast channel.

### CROSS-REFERENCE TO RELATED PATENT APPLICATION

This application claims the priority of Korean Patent Application No. 10-2007-0004968, filed on Jan. 16, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to a method and apparatus for providing personal broadcast content, and more particularly, to a server and method for providing a personal broadcast content service and an apparatus and method for generating personal broadcast content using information provided by the server.

2. Description of the Related Art

Recently, digital broadcast methods, such as digital television (DTV) and digital multimedia broadcasting (DMB), have been widely used. In addition, wireless mobile Internet, such as wireless local area network (LAN) and wireless broadband Internet (WiBro), which enables users to access ultra high-speed Internet while on the move, has been introduced. Accordingly, the convergence of broadcasting and communications is drawing a lot of attention. The development of new content and receivers through the convergence of broadcasting and communications is gaining momentum as a new trend in the information and technology (IT) of the future. However, a model, which properly represents the convergence of broadcasting and communications, has not yet been suggested. Content has been developed with an aim to converge broadcasting and communications. However, the content does not represent a perfect convergence between data received through a communication network and that received through a broadcast network. Instead, the content provides only an interface for moving from a program of an individual network to a program of another network.

DMB providers have attempted to provide users with a service that converges broadcasting and communications. This convergence service enables the users to receive a service through a communication network while watching DMB. To provide the convergence service, a binary format for scenes (BIFS) of a moving picture experts group (MPEG)-4 system (International Organization for Standardization (ISO)/International Electrotechnical Commission (IEC) 14496-1) is mainly used. The BIFS has information regarding when, where and how video, audio, graphics, images, text are to be represented on a screen as screen technology information of the MPEG-4 system.

One of the properties of the BIFS is an ‘anchor’ element which has a hyperlink function as in a web page. When an input is received from a user, the ‘anchor’ element enables a switch to another predetermined service. A service currently conceived by broadcasting stations is to use the ‘anchor’ element of the BIFS. That is, when a user is using an additional data service provided through the BIFS while watching DMB, the user may switch to a relevant service provided through a communication network or wireless Internet. Specifically, the location of a service of a communication network may be transmitted to the ‘anchor’ element, and a user may select a service in a BIFS using an input device such as a mouse. Then, the user can receive the service, which is separate from a DMB service that the user has been watching, through the communication network. After all, the ‘anchor’ element functions only as a trigger for switching from the DMB service to the service provided by the communication network.

The convergence service can also be provided using a broadcasting website service (BWS) in addition to DMB. The BWS is a service which provides the content of a website through DMB. Since the BWS combines broadcasting with the Internet, existing Internet content can directly be delivered to DMB. In addition, since the content is expressed in hypertext markup language (HTML), it can be easily linked with a bi-directional network. Therefore, a DMB terminal having the bi-directional network can move to an Internet service using the BWS. However, like the convergence service using the BIFS, the convergence service using the BWS provides only a function for switching from a broadcast content service to an Internet service.

The importance of the convergence between broadcasting and communications has been sufficiently emphasized, and the need for developing a new service, which converges broadcasting and communications, has been shared by all, ranging from broadcasting stations and content developers to receiver developers. However, conventional services suggested until now do not represent convergence between broadcasting and communications. They are simply a combination of different networks.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

Exemplary embodiments of the present invention provides a server and method which can overcome the limitations of a conventional service that converges broadcasting and communications, emphasizing the difference of each network through a true convergence of content from different networks, and provide various services to users.

The present invention also provides a user terminal device and method for generating personal broadcast content using information received from the server.

According to an aspect of the present invention, there is provided a server including a communication unit receiving one or more pieces of content and metadata required by a user terminal apparatus, which is connected thereto by a bi-directional communication network, to obtain the content from one or more content providers providing the content through a broadcast network and the bi-directional communication network; a storage unit storing the content and the metadata; and a control unit providing the user terminal apparatus with the metadata and an authoring tool used to configure a personal broadcast screen, which contains the content received through the broadcast network and the bi-directional communication network, and to generate personal broadcast content by controlling the communication unit.

If the content is a broadcast program, the metadata may include at least one of broadcast program information, information needed to search for the content, information needed to decode the content, and location information of the content.

The authoring tool may be an application which processes at least one of binary format for scenes (BIFS) information, lightweight application scene representation (LASER) information and scalable vector graphic (SVG) information and configures a screen for personal broadcast content.

The control unit may provide as the authoring tool a screen configuration template into which broadcast content can be selected and inserted.

The authoring tool may be changed according to time and provided accordingly.

The control unit may receive personal broadcast content generated by one or more user terminal apparatuses using the authoring tool from the user terminal apparatuses, generate and manage a list of the personal broadcast content, and control the communication unit to provide one of the user terminal apparatuses with personal broadcast content selected by the user terminal apparatus at the request of the user terminal apparatus.

According to another aspect of the present invention, there is provided a method of providing a personal broadcast content service. The method includes receiving one or more pieces of content and metadata required by a user terminal apparatus, which is connected by a bi-directional communication network, to obtain the content from one or more content providers providing the content through a broadcast network and the bi-directional communication network; storing the content and the metadata; and providing the user terminal apparatus with the metadata and an authoring tool used to configure a personal broadcast screen, which contains the content received through the broadcast network and the bi-directional communication network, and to generate personal broadcast content.

According to another aspect of the present invention, there is provided a user terminal apparatus including a broadcast reception unit receiving broadcast content through a broadcast network; a communication unit controlling connection with a server which provides an authoring tool for generating personal broadcast content and metadata required to obtain one or more pieces of content through the broadcast network and a bi-directional communication network; a user input unit receiving a user input signal; and a control unit configuring a personal broadcast screen, which contains the content, using the authoring tool and the metadata and generating personal broadcast content in response to the user input signal.

The control unit may obtain one or more pieces of content for configuring the personal broadcast screen through a bi-directional communication network or the broadcast network in response to the user input signal, place the obtained content at a predetermined location of the personal broadcast screen, and thus configure the personal broadcast screen.

The authoring tool may be an application which processes at least one of BIFS information, LASER information and SVG information and configures a screen for personal broadcast content.

The authoring tool may be a screen configuration template into which broadcast content can be selected and inserted.

The user terminal apparatus may further include an output unit outputting the configured personal broadcast screen, wherein the control unit receives from the server a list of personal broadcast content generated by one or more user terminal apparatuses using the authoring tool, outputs the received list to the output unit, and controls the communication unit to obtain personal broadcast content selected based on the user input signal for selecting a piece of personal broadcast content in the list.

The control unit may control the broadcast reception unit to process the personal broadcast content received through a broadcast signal.

According to another aspect of the present invention, there is provided a method of generating personal broadcast content. The method includes accessing a server which provides an authoring tool for generating personal broadcast content and metadata required to obtain one or more pieces of content through a broadcast network and a bi-directional communication network; receiving the authoring tool and the metadata from the server; and configuring a personal broadcast screen, which contains the content, using the authoring tool and the metadata and generating personal broadcast content in response to a user input signal.

### BRIEF DESCRIPTION OF THE DRAWINGS

The above and other features of the present invention will become more apparent by describing in detail exemplary embodiments thereof with reference to the attached drawings in which:

FIG. 1 is a block diagram of a system for implementing a personal broadcast service according to an exemplary embodiment of the present invention;

FIG. 2 is a block diagram of a clog server providing an authoring tool which is used to generate personal broadcast content according to an exemplary embodiment of the present invention;

FIG. 3 is a block diagram of a user terminal apparatus generating personal broadcast content using an authoring tool which is obtained from a clog server according to an exemplary embodiment of the present invention;

FIG. 4 is a flowchart illustrating a method of providing a personal broadcast content service using a clog server according to an exemplary embodiment of the present invention;

FIG. 5 is a flowchart illustrating a method of generating personal broadcast content using a user terminal apparatus according to an exemplary embodiment of the present invention;

FIG. 6A shows a conventional broadcast screen; and

FIGS. 6B through 6D show a broadcast screen providing personal broadcast content generated according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

FIG. 1 is a block diagram of a system for implementing a personal broadcast service according to an exemplary embodiment of the present invention.

In FIG. 1, a broadcasting station 100 is a content provider providing broadcast programs through a broadcast network. The broadcasting station 100 provides broadcast content and metadata of the broadcast content to a clog server 200 as indicated by an arrow 10.

A content server 400 provides content through a bi-directional communication network. The content server 400 provides content and metadata of the content to the clog server 200 as indicated by an arrow 11.

The clog server 200 provides an authoring tool for generating personal broadcast content according to an exemplary embodiment of the present invention, metadata received from the broadcasting station 100, and metadata received from the content server 400 to a user terminal apparatus 300 as indicated by an arrow 12. Clog is a compound word of broadcast and blog. A clog service denotes a service which enables a user to configure a personal broadcast screen and generate personal broadcast content using one or more pieces of content received through a broadcast network and a bi-directional communication network.

The authoring tool for generating personal broadcast content may be an application that configures a screen for personal broadcast content using languages for screen configuration, such as binary format for scenes (BIFS) information, lightweight application scene representation (LASER) information, and scalable vector graphic (SVG) information. In addition, the authoring tool for generating personal broadcast content may be in the form of a screen configuration template into which broadcast content can be selected and inserted.

In this specification, metadata generally refers to information needed for the user terminal apparatus 300, which is connected to the bi-directional communication network, to obtain content. Therefore, there may be various forms of metadata for each piece of content. If content is a broadcast program, metadata may include an electronic program guide (EPG) and at least one of general information of the content, information needed to search for the content, information needed to decode the content, and location information of the content.

The general information of content may be information regarding content, such as title and size of the content.

If the content is video content (or a video object), the information needed to search for content may contain intra frame information as preview information and provided to a user. The preview information is used to give a user a preview of a corresponding object. Even when the content is audio content, the metadata, i.e., the information needed to search for content, may include part of the content by which the user can recognize a corresponding object.

The information needed to decode content is configuration information of a decoder required to configure a screen. For example, if content included in screen configuration is composed of audio/video (AV) objects or multimedia objects, the information needed to decode content may include information required to initialize a software or hardware processor for decoding these objects.

The metadata may also include time stamp information for screen configuration. For example, if content included in screen configuration is composed of AV objects or multimedia objects, the metadata may include a presentation time stamp (PTS) or a decoding time stamp (DTS) of each of the objects.

The information needed to search for content may include uniform resource locator (URL) information of a server which stores the content. If content selected by the user using the user terminal apparatus 300 is not stored in the clog server 200, the user may obtain the content using URL information provided by the clog server 200.

The user terminal apparatus 300 obtains an authoring tool and metadata from the clog server 200 as indicated by the arrow 12. The user configures a broadcast screen using the authoring tool and the metadata and generates personal broadcast content using the user terminal apparatus 300. If content, which is selected by the user and placed on the broadcast screen, is stored in the clog server 200, the user terminal apparatus 300 may obtain the content from the clog server 200. Otherwise, the user terminal apparatus 300 may obtain the content directly from the broadcasting station 100 and the content server 400. That is, the user terminal apparatus 300 may obtain broadcast content from the broadcasting station 100 through the broadcast network as indicated by an arrow 13 and obtain content from the content server 400 through the bi-directional communication network as indicated by an arrow 14.

Music broadcasts provided in this clog service will now be described. Generally, a music broadcast provides music videos of singers. However, the music broadcast does not provide information regarding the singers or music other than information provided through the music videos. On the other hand, users of the clog service according to the present invention can configure a new music broadcast screen by combining additional data or content that the users are interested in or have knowledge about with a music video and thus generate personal music broadcast content.

For example, a user may obtain a music video through a broadcast network and obtain detailed information regarding dance motions in the music video and personal information of back-up dancers from the clog server 200 or other content servers. Accordingly, the user may generate personal broadcast content including the music video and the above information regarding the dance motions and the back-up dancers. Another user may generate personal broadcast content including daily information of a singer who is a main character of the music video or including information regarding a playing method, such as musical instruments and music notes used in the music.

The clog server 200 receives personal broadcast content generated by each of the user terminal apparatus 300 and other user terminal apparatuses and provides various services. For example, the clog server 200 may provide a list of personal broadcast content to the user terminal apparatuses. Therefore, users using the clog server can be provided with personal broadcast content which is created by other users. If a user desires to obtain information regarding a dance of a singer in a music video in addition to the music video as in the above example, the user may select and use personal broadcast content which contains detailed information regarding dance motions and which is generated by another user. Hence, the user can obtain abundant information regarding the dance.

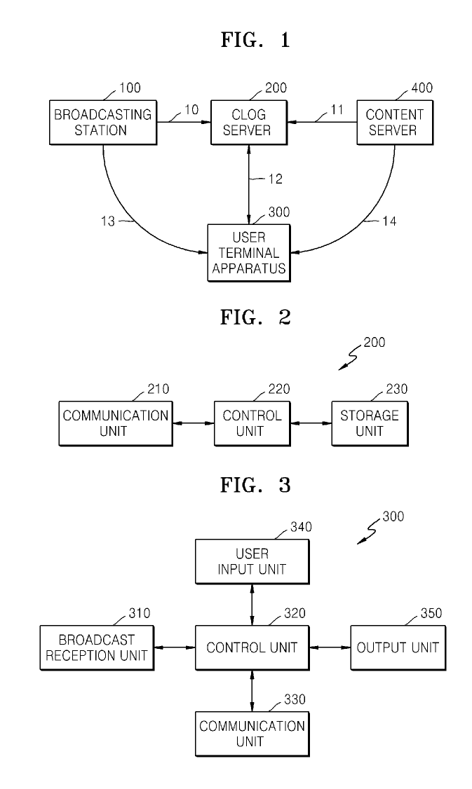

FIG. 2 is a block diagram of a clog server 200 providing an authoring tool which is used to generate personal broadcast content according to an exemplary embodiment of the present invention illustrated in FIG. 1. Referring to FIG. 2, the clog server 200 includes a communication unit 210, a control unit 220, and a storage unit 230.

The communication unit 210 receives one or more pieces of content and metadata required by the user terminal apparatus 300, which is connected thereto through a bi-directional communication network, to obtain the content from one or more content providers who provide the content through a broadcast network and the bi-directional communication network.

The storage unit 230 stores content and metadata of the content. The content and the metadata may be classified by broadcast program and stored accordingly. The clog server 200 provides available information regarding the content to the user terminal apparatus 300. If the user terminal apparatus 300 selects content, the clog server 200 retrieves the selected content and metadata of the selected content from the storage unit 230 and provides them to the user terminal apparatus 300.

The control unit 220 provides the user terminal apparatus 300 with an authoring tool and metadata used to configure a personal broadcast screen, which contains content transmitted through the broadcast network and the bi-directional communication network, and to generate personal broadcast content by controlling the communication unit 210.

The control unit 220 may provide, as the authoring tool, an application which configures a screen for personal broadcast content using languages for screen configuration, such as BIFS information, LASER information and SVG information. Alternatively, the control unit 220 may provide a screen configuration template, into which broadcast content can be selected and inserted, as the authoring tool for generating personal broadcast content. The type or form of the authoring tool is not limited to a particular type or form as long as the authoring tool is an application that can be provided to the user terminal apparatus 300 and used by a user to configure a screen.

The authoring tool may be provided at each time slot at the request of the user terminal apparatus 300. For example, if a screen configuration template is provided to a user, the user may watch a broadcast program provided in a clog service on a screen, which includes a plurality of pieces of content in addition to the broadcast program, from 12:00 to 01:00 p.m. Then, from 01:00 p.m., the user may watch the broadcast program on a screen that provides only the broadcast program.

The control unit 220 may also receive personal broadcast content generated by one or more user terminal apparatuses using an authoring tool from the user terminal apparatuses, store the received personal broadcast content in the storage unit 230, and generate and manage a list of personal broadcast content. At the request of any one of the user terminal apparatus 300 and other user terminal apparatuses, the control unit 220 may transmit personal broadcast content to a corresponding user terminal apparatus.

Therefore, a user can obtain a desired screen configuration format for personal broadcast content while viewing the list of personal broadcast content through the user terminal apparatus 300 or watch personal broadcast content generated by another user. In addition, the control unit 220 may provide to the user terminal apparatus 300 a list of personal broadcast content recommended according to the number of times that each piece of personal broadcast content has been requested by the user terminal apparatus 300 and other user terminal apparatuses or according to a predetermined standard.

FIG. 3 is a block diagram of a user terminal apparatus 300 generating personal broadcast content using an authoring tool which is obtained from a clog server 200 according to an exemplary embodiment of the present invention illustrated in FIG. 1. The user terminal apparatus 300 includes a broadcast reception unit 310, a control unit 320, a communication unit 330, a user input unit 340, and an output unit 350.

The broadcast reception unit 310 processes broadcast programs received through a broadcast network. The broadcast reception unit 310 may be configured, for example, according to a path (e.g., a satellite, terrestrial, or cable network) through which broadcast signals are received and types of broadcast services (e.g., digital multimedia broadcasting (DMB)).

The control unit 320 controls transmission and reception of data between the units included in the user terminal apparatus 300. In addition, the control unit 320 processes an authoring tool and metadata received from the clog server 200 via the communication unit 330.

The communication unit 330 controls connection to a server, which provides an authoring tool for generating personal broadcast content and metadata required to obtain one or more pieces of content through a broadcast network and a bi-directional communication network, and other content provision servers.

The user input unit 340 receives a user input signal and transmits the received user input signal to the control unit 320. The control unit 320 obtains one or more pieces of content for configuring a screen for personal broadcast content through the bi-directional communication network or the broadcast network in response to the user input signal, places the obtained content at a predetermined location of the screen, and thus configures the screen. The content may be obtained from the clog server 200 or the content provision server 400 or from broadcast signals received from the broadcasting station 100 and displayed on the screen.

If an application, which configures a screen for personal broadcast content by processing at least one of the BIFS information, LASER information and SVG information, is provided as an authoring tool, a user may execute the application or perform programming for configuring a broadcast screen, thereby configuring the screen. If an authoring tool in the form of a screen configuration template is provided, the user may insert desired content and content, which is received through the bi-directional communication network, into the screen configuration template and thus configure the screen.

The control unit 320 controls the broadcast reception unit 310 to process a broadcast program received through a broadcast channel, through which broadcast content selected by the broadcast reception unit 310 is transmitted, so that the user can place a selected broadcast program on the screen and thus configure the screen. In addition, the control unit 320 processes the broadcast content selected by the user and the content received through the bi-directional communication network to be placed and displayed at a desired location of the screen. To this end, the control unit 320 may include a module for decoding the content or a module for adjusting the size of the content to be suitable for the size of the screen on which the content is placed.

The output unit 350 outputs screen configuration, which is processed and generated by the control unit 320, in response to the user input signal. The control unit 320 may store the generated personal broadcast content in a predetermined storage space (not shown). The storage space may be included in the control unit 320 or the user terminal apparatus 300. The control unit 320 may also store the generated personal broadcast content in an external storage medium.

The control unit 320 may transmit the generated personal broadcast content to the clog server 200 via the communication unit 330. If the clog server 200 receives personal broadcast content generated by one or more user terminal apparatuses using an authoring tool from the user terminal apparatuses and provides a list of personal broadcast content, the control unit 320 may output the list received through the communication unit 340 on the output unit 350. If a user input signal for selecting a piece of personal broadcast content from the output list is received from the user input unit 340, the control unit 320 may control the communication unit 330 to obtain the selected personal broadcast content.

In the clog server according to the present invention, the generated personal broadcast content may be provided by the clog server 200 as described above. However, the clog server 200 may provide the personal broadcast content received from the user terminal apparatuses to a broadcasting station, and the broadcasting station may provide the personal broadcast content received from the clog server 200 to the user terminal apparatus 300 using a broadcast signal. When the broadcasting station provides broadcast program information, it may include information regarding the personal broadcast content, which is generated according to the clog service provided by the clog server 200, in the EPG information and provide the EPG information to the user terminal apparatus 300.

Therefore, the user terminal apparatus 300 can receive the personal broadcast content and the information regarding the personal broadcast content not only from the clog server 200 but also from the broadcasting station. Here, the control unit 320 may control the broadcast reception unit 310 to process personal broadcast content received through a broadcast signal.

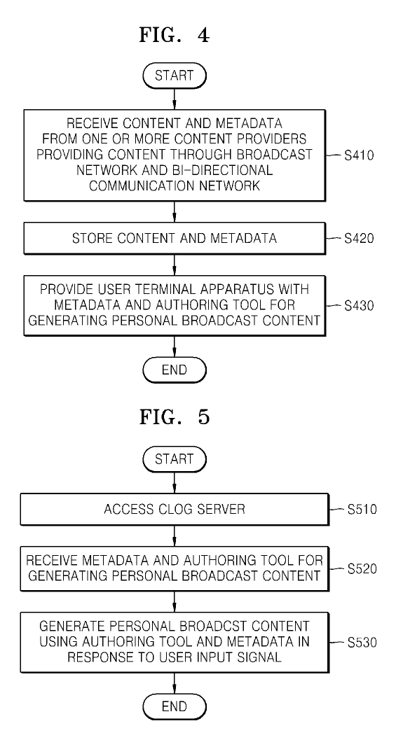

FIG. 4 is a flowchart illustrating a method of providing a personal broadcast content service using the clog server 200 according to an exemplary embodiment of the present invention.

In operation S410, the clog server 200 receives one or more pieces of content and metadata required by one or more user terminal apparatuses, which are connected thereto by a bi-directional network, to obtain the content from one or more content providers who provide the content through a broadcast network and the bi-directional communication network.

In operation S420, the clog server 200 stores the content and the metadata.

In operation S430, if a user terminal apparatus 300 is connected to the clog server 200, the clog server 200 provides an authoring tool, which is used to configure a personal broadcast screen that contains content received through the broadcast network and the bi-directional communication network and create personal broadcast content, and metadata to the user terminal apparatus 300.

The clog server 200 receives personal broadcast content generated by one or more user terminal apparatuses using the authoring tool from the user terminal apparatuses and manages a list of personal broadcast content. If the user terminal apparatus 300 selects personal broadcast content in the list, the clog server 200 provides the selected personal broadcast content to the user terminal apparatus 300.

FIG. 5 is a flowchart illustrating a method of generating personal broadcast content using the user terminal apparatus 300 according to an exemplary embodiment of the present invention.

In operation S510, the user terminal apparatus 300 is connected to the clog server 200 which provides an authoring tool used to generate personal broadcast content.

In operation S520, the user terminal apparatus 300 receives from the clog server 200 the authoring tool and metadata required to obtain content through a bi-directional communication network and a broadcast network.

In operation S530, in response to a user input signal, the user terminal apparatus 300 generates personal broadcast content by configuring a broadcast screen, which contains the content received through the bi-directional communication network and the broadcast network, using the authoring tool and the metadata. Here, in response to the user input signal, the user terminal apparatus 300 places selected content at a predetermined location of the broadcast screen and thus configures the broadcast screen. The content placed in the screen may be obtained from broadcast programs received through the broadcast network and obtained from the clog server 200 or other content provision servers through the bi-directional communication network. The content is processed by the user terminal apparatus 300 and output accordingly.

In response to the user input signal, the user terminal apparatus 300 may store personal broadcast content. In addition, the user terminal apparatus 300 may transmit the personal broadcast content to the clog server 200. The clog server 200 may manage personal broadcast content received from the user terminal apparatus 300 and other user terminal apparatuses and provide a list of personal broadcast content. The user terminal apparatus 300 may receive the list of personal broadcast content, select desired personal broadcast content, and obtain the selected personal broadcast content from the clog server 200.

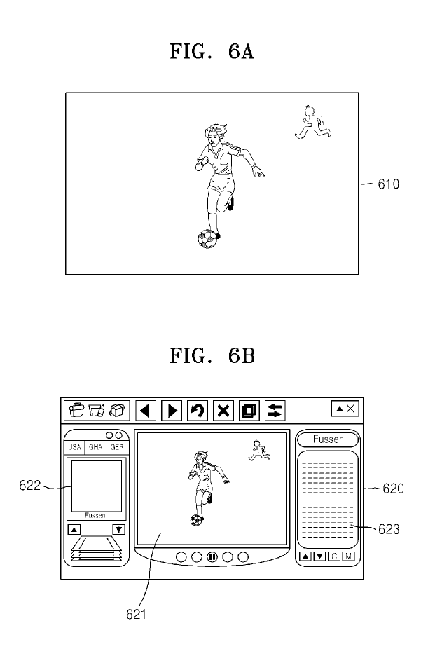

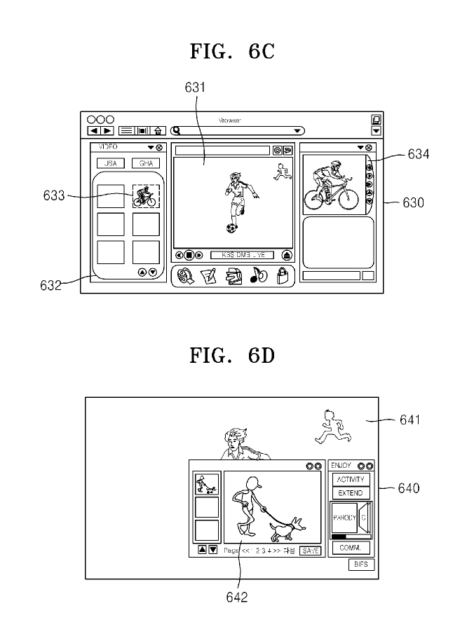

FIG. 6A shows a conventional broadcast screen. FIGS. 6B through 6D show a broadcast screen providing personal broadcast content generated according to an exemplary embodiment of the present invention.

Referring to FIG. 6A, a broadcast program about a soccer game received through a broadcast network is provided on an entire screen 610 of a conventional user terminal apparatus which receives and provides a broadcast program.

If a clog service according to the present invention is used, the user terminal apparatus can provide content, which can be obtained through a bi-directional communication network, in addition to the broadcast program as illustrated in FIGS. 6B through 6D.

Referring to FIG. 6B, a screen 620 includes a screen 621 providing the soccer game and a screen 622 displaying image information of the city ‘Fussen’ where the soccer game is held. In addition, the screen 620 includes a screen 623 on which text information of Fussen can be displayed. Referring to FIG. 6C, a screen 630 includes a screen 631 displaying the soccer game and a screen 632 providing information regarding other sports games. If a user selects one 633 of image information, an enlarged image 634 is provided. Referring to a screen 640 of FIG. 6D, the soccer game is provided on an entire screen 641, and a movie is provided on another screen 642. Therefore, if a user terminal apparatus provides a soccer game being broadcast through a broadcast channel, a user can configure various broadcast screens as illustrated in FIGS. 6B through 6D and watch the soccer game on a screen of desired configuration. In addition, based on desired additional data, the user can select personal broadcast content as illustrated in FIGS. 6B through 6D and receive the selected personal broadcast content from the clog server 200.

The present invention can also be implemented as computer-readable code on a computer-readable recording medium. Also, code and code segments for accomplishing the present invention can be easily construed by programmers skilled in the art to which the present invention pertains.

The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage apparatuses.

The computer-readable recording medium can also be distributed over network-coupled computer systems so that the computer-readable code is stored and executed in a distributed fashion.

As described above, the present invention provides a clog server and method for providing a clog service which enables a user to generate personal broadcast content and a user terminal apparatus and method for generating personal broadcast content using the clog service.

The clog service implements service convergence. If this clog service is used, users can select and obtain desired content from content provided through the broadcast network and the bi-directional communication network and generate personal broadcast content. In this case, content provided through the bi-directional communication network can be seamlessly combined with the content provided through the broadcast network into a new service. Therefore, through the clog service, users can enjoy a plurality of services based on a piece of broadcast content. In addition, the users can enjoy more personalized services.

Broadcasting stations can also create a new profit model by providing broadcast content to other content providers and thus provide various content-based services to users. In this case, in order to smoothly synchronize the broadcast content with content provided by content providers, the broadcasting stations can set a different relationship with each content provider by sharing different information with each content provider.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A server comprising:
a communication unit which receives at least one piece of content and corresponding at least one of metadata required by a user terminal apparatus which is connected to the communication unit by a bi-directional communication network, to obtain the at least one piece of content from one or more content providers providing the at least one piece of content through a broadcast network and the bi-directional communication network;
a storage unit which stores the at least one piece of content and the at least one of metadata; and
a control unit which provides the user terminal apparatus with the at least one of metadata and an authoring tool operable to configure a personal broadcast screen, which contains the at least one piece of content received through the broadcast network and the bi-directional communication network, and to generate personal broadcast content by controlling the communication unit.

2. The server of claim 1, wherein, if the at least one piece of content is a broadcast program, the at least one of metadata comprises at least one of broadcast program information, information to search for the at least one piece of content, information to decode the at least one piece of content, and location information of the at least one piece of content.

3. The server of claim 1, wherein the authoring tool is an application which processes at least one of binary format for scenes (BIFS) information, lightweight application scene representation (LASER) information and scalable vector graphic (SVG) information and configures a screen for the personal broadcast content.

4. The server of claim 1, wherein the control unit provides as the authoring tool a screen configuration template into which the personal broadcast content is selected and inserted.

5. The server of claim 1, wherein the authoring tool is changed according to time and provided according to the time.

6. The server of claim 1, wherein the control unit receives personal broadcast content generated by one or more user terminal apparatuses using the authoring tool from the one or more user terminal apparatuses, generates and manages a list of the personal broadcast content, and controls the communication unit to provide the one of the one or more user terminal apparatuses with the personal broadcast content selected by the user terminal apparatus, at the request of the user terminal apparatus.

7. A method of providing a personal broadcast content service, the method comprising:
receiving at least one piece of content and corresponding at least one of metadata required by a user terminal apparatus which is connected to a bi-directional communication network, to obtain the at least one piece of content from one or more content providers providing the at least one piece of content through a broadcast network and the bi-directional communication network;
storing the at least one piece of content and the at least one of metadata; and
providing the user terminal apparatus with the at least one of metadata and an authoring tool to configure a personal broadcast screen, which contains the at least one piece of content received through the broadcast network and the bi-directional communication network, and to generate personal broadcast content.

8. The method of claim 7, wherein, if the at least one piece of content is a broadcast program, the at least one of metadata comprises at least one of broadcast program information, information to search for the at least one piece of content, information to decode the at least one piece of content, and location information of the at least one piece of content.

9. The method of claim 7, wherein the authoring tool is an application which processes at least one of BIFS information, LASER information and SVG information and configures a screen for the personal broadcast content.

10. The method of claim 7, wherein the authoring tool is a screen configuration template into which the personal broadcast content is selected and inserted.

11. The method of claim 7, wherein the authoring tool is changed according to time and provided according to the time.

12. The method of claim 7, further comprising:
receiving personal broadcast content generated by one or more user terminal apparatuses using the authoring tool from the user terminal apparatuses;
generating and managing a list of the personal broadcast content; and
providing one of the user terminal apparatuses with personal broadcast content selected by the user terminal apparatus at a request of the user terminal apparatus.

13. A user terminal apparatus comprising:
a broadcast reception unit which receives broadcast content through a broadcast network;
a communication unit which controls connection with a server which provides an authoring tool for generating personal broadcast content and metadata required to obtain at least one piece of content through the broadcast network and a bi-directional communication network;
a user input unit which receives a user input signal; and
a control unit which configures a personal broadcast screen, which contains the at least one piece of content, using the authoring tool and the metadata and generating the personal broadcast content in response to the user input signal.

14. The user terminal apparatus of claim 13, wherein the control unit obtains at least one piece of content to configure the personal broadcast screen through a bi-directional communication network or the broadcast network in response to the user input signal, and places the obtained at least one piece of content at a predetermined location of the personal broadcast screen to configure the personal broadcast screen.

15. The user terminal apparatus of claim 13, wherein the authoring tool is an application which processes at least one of BIFS information, LASER information and SVG information and configures a screen for the personal broadcast content.

16. The user terminal apparatus of claim 13, wherein the authoring tool is a screen configuration template into which the personal broadcast content is selected and inserted.

17. The user terminal apparatus of claim 13, further comprising an output unit which outputs the configured personal broadcast screen, wherein the control unit receives from the server a list of personal broadcast content generated by one or more user terminal apparatuses using the authoring tool, outputs the received list to the output unit, and controls the communication unit to obtain the personal broadcast content selected based on the user input signal for selecting a piece of the personal broadcast content in the list.

18. The user terminal apparatus of claim 13, wherein the control unit controls the broadcast reception unit to process the personal broadcast content received through a broadcast signal.

19. A method of generating personal broadcast content, the method comprising:
accessing a server which provides an authoring tool for generating personal broadcast content and metadata to obtain at least one piece of content through a broadcast network and a bi-directional communication network;
receiving the authoring tool and the metadata from the server; and
configuring a personal broadcast screen, which contains the at least one piece of content, using the authoring tool and the metadata and generating personal broadcast content in response to a user input signal.

20. The method of claim 19, wherein the configuring of the personal broadcast screen comprises:
obtaining at least one piece of content to configure the personal broadcast screen through the bi-directional communication network or the broadcast network in response to the user input signal; and
placing the obtained at least one piece of content at a predetermined location of the personal broadcast screen to configure the personal broadcast screen.

21. The method of claim 19, wherein the authoring tool is an application which processes at least one of BIFS information, LASER information and SVG information and configures a screen for the personal broadcast content.

22. The method of claim 19, wherein the authoring tool is a screen configuration template into which the broadcast content is selected and inserted.

23. The method of claim 19, further comprising:
accessing the server, receiving from the server a list of personal broadcast content generated by one or more user terminal apparatuses using the authoring tool, and outputting the received list; and
obtaining personal broadcast content selected through the user input signal for selecting the personal broadcast content in the list.

24. A computer-readable recording medium on which a program for executing a method of providing a personal broadcast content service is recorded, the method comprising:
receiving at least one piece of pieces of content and corresponding at least one of metadata required by a user terminal apparatus, which is connected to a bi-directional communication network, to obtain the at least one piece of content from one or more content providers providing the at least one piece of content through a broadcast network and the bi-directional communication network;
storing the at least one piece of content and the at least one metadata; and
providing the user terminal apparatus with the at least one of metadata and an authoring tool to configure a personal broadcast screen, which contains the at least one of content received through the broadcast network and the bi-directional communication network, and to generate personal broadcast content.

25. A computer-readable recording medium on which a program for executing a method of generating personal broadcast content is recorded, the method comprising:
accessing a server which provides an authoring tool for generating personal broadcast content and metadata to obtain at least one piece of content through a broadcast network and a bi-directional communication network;
receiving the authoring tool and the metadata from the server; and
configuring a personal broadcast screen, which contains the at least one piece of content, using the authoring tool and the metadata and generating personal broadcast content in response to a user input signal.
